(19) United States
(12) Patent Application Publication
(10) Pub. No.: US 2006/0130389 A1
(43) Pub. Date: Jun. 22, 2006

(54) Fly line to leader connector

(76) Inventor: Ronald B. Annelin, Manistique, MI (US)

Correspondence Address: MARY J. GASKIN;ANNELIN & GASKIN, 2170 BUCKTHORNE PL., SUITE 220, THE WOODLANDS, TX, 77380, US

(21) Appl. No.: 11/016,056

(22) Filed: Dec. 17, 2004

(51) Int. Cl. A01K 91/047; A01K 91/16

(52) U.S. Cl. 43/44.98

(57) ABSTRACT

A fly line to leader connector comprising a leader with a modified, enlarged butt end, a securing collar, and a length of heat-shrinkable tubing, which contracts upon the application of heat. The result is a smooth, knotless connection between lines of dissimilar sizes and/or materials. Optionally, adhesive can be applied to the bore of the tubing. Additionally, shallow grooves can be inscribed on the surface of the end of the fly line.

### FIELD OF THE INVENTION

The present invention relates primarily to the field of fly fishing, with application in other fields for connecting two lengths of material having dissimilar diameters.

### BACKGROUND OF THE INVENTION

The art of fly fishing as presently practiced requires the attachment of fine, often tapered, monofilament leader line to thicker, woven, coated fly lines. The fly line, in its various manifestations (e.g., floating, sinking, shooting) provides the mass that is essential to propel the fly against air resistance to the fisherman's desired target. However, the fly line itself is too large to attach to a fly; further, its size will alert wary fish to the presence of an unnatural condition, thereby reducing the capture of fish. As a result, fishermen join a fine, less obtrusive leader line to the fly line, and attach the fly to the leader line.

Because the fly line and the leader line are dissimilar in both material and diameter, they are difficult to join together. Presently, special knots are often used, but such knots are difficult and time-consuming to tie, especially for fishermen with limited eyesight or dexterity. Further, the knots increase the overall diameter of the line, impeding the movement of the leader and fly line through the ferrules, or guides, of the fly rod.

To avoid the necessity of joining the leader and fly line with knots, sportsmen have developed a number of mechanical, adhesive, and splice connectors. Examples of these connections are disclosed in U.S. Pat. No. 4,604,821 to Moser (discloses a mesh “Chinese finger trap”); U.S. Pat. No. 4,864,767 to Drosdak (discloses a clamp connector) and; U.S. Patent No. 5,469,652 to Drosdak (discloses a threaded connector). However, none of these discloses a connector with the utility and advantages of the invention disclosed herein.

### SUMMARY OF THE INVENTION

Using the present invention, a fisherman can connect a leader line to a fly line easily and effectively. The leader line used has a modified, enlarged butt end, either prefabricated or one that has been mechanically altered. The fly end of the leader is passed through a longitudinal opening in a cylindrical collar until stopped by the enlarged end. The butt end and collar are then slid into one end of a piece of heat shrinkable tubing, and the free end of the fly line is slid into the other end of the tubing, until it rests against the enlarged butt end of the leader line. The fisherman then applies heat to the tubing with a heat gun, or flame, causing it to contract, with the result that the end of the leader is fixedly attached to the end of the fly line. Optionally, the fisherman can use a piece of heat shrinkable tubing which includes a heat-activated adhesive material on the inner surfaces of the tubing, in order to provide an even stronger connection. In addition, shallow grooves can be inscribed on the surface of the end of the fly line, resulting in a stronger connection.

It is an object of the present invention to provide an easy-to-use connector to join two lines of dissimilar size and material (e.g., a fly line and a leader).

Another object of the present invention is to provide a connector comprising a securing collar for the end of the leader line, and a piece of heat shrinkable tubing.

Yet another object of the present invention is to provide a securing collar that can be manufactured from materials, having different densities, the choice depending on the type of fly fishing being practiced (e.g., in dry fly fishing, the fly stays on the water's surface, in wet fly fishing, the lure is presented under the water surface).

A further object of the present invention is to provide a connector for a leader line to a fly line that results in a linear presentation, assuring that the leader and fly line are maintained in a line.

A still further object of the present invention is to provide a connector which does not impede the smooth movement of the fly line and leader line through the fly rod's guides.

### BRIEF DESCRIPTION OF THE DRAWINGS

FIGS. 1A through 1C show three different leader lines, each with a different enlarged butt end, with which the connector of the present invention may be used.

FIGS. 2A and 2B show side perspective views of two different securing collars which can be used as part of the connector of the present invention.

FIG. 3 shows a side perspective view of the heat shrinkable tubing used as part of the connector of the present invention.

FIG. 4 is an enlarged, partially sectional view of the assembled parts of the connector prior to completion of the attachment of the leader line to the fly line.

FIG. 5 is an enlarged side perspective view of the connector, showing the completed attachment of the leader line to the fly line, after heat has been applied.

### DESCRIPTION OF THE PREFERRED EMBODIMENT

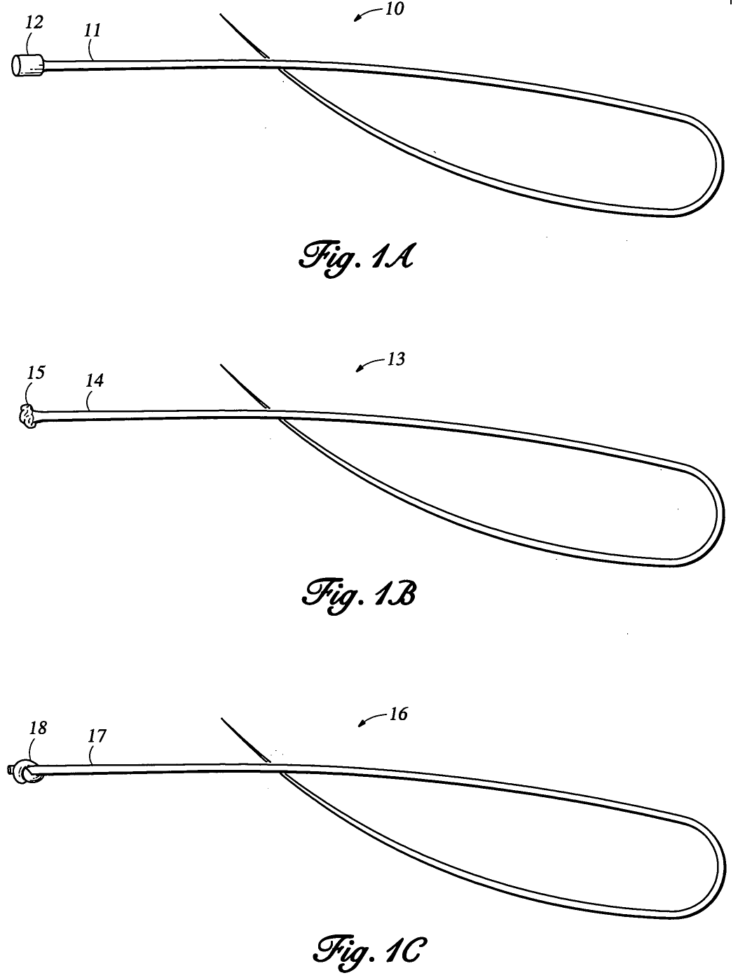

As shown in FIGS. 1A through 1C, the butt ends of leader lines may be modified in different ways for use with the connector of the present invention.

In FIG. 1A, a monofilament, tapered leader line 10 has a butt end 11 which was modified during manufacture to form an expanded end 12 with a diameter approximating that of a fly line. In FIG. 1B, leader line 13 has a butt end 14 which has been expanded in the field by use of heat from a heat gun or a match in order to form a protuberance 15 with a diameter approximating that of a fly line. In FIG. 1C, leader line 16 has a butt end 17 which has been enlarged in the field by tying an overhand knot 18 with a diameter approximating that of a fly line.

FIGS. 2A and 2B show the securing collars 20, 21 through which the narrower end of a leader line 10, 13, 16 can be threaded until the expanded end 12, protuberance 15, or knot 18 is snug against the first end 22, 23 of the securing collar 20, 21. FIG. 2A shows a securing collar 20 with a flat second end 24. FIG. 2B shows a securing collar 21 with a tapered second end 25. The securing collar 20, 21 can be manufactured using a rigid or semi-rigid material, with the density selected depending on the fisherman's preference. For instance, low density materials, less than 1.0 g/cc, would be preferable for dry fly fishing in order to reduce the tendency of the leader to sink. Examples of low density materials include rigid silicone tubing and porous ceramics. A high density material would be preferable for wet fly fishing because it would increase line sink rate. Examples of high density materials include lead or bismuth alloys and ceramic. The dimensions of the securing collar 20, 21 used depend on the weight (size) of the fly line and leader line. The outer diameter (O.D.) of the securing collar 20, 21 should approximate the outer diameter of the fly line selected. The inner diameter (I.D.) of the securing collar 20, 21 should be slightly greater than the outer diameter of the butt end 11, 14, 17 of the leader line 10, 13, 16 prior to its enlargement. The thickness of the wall 26, 27 of the securing collar 20, 21 depends on the fly line and leader weight combination, as well as the material selected; in any event, the wall 26, 27 must be sufficiently strong enough to prevent the expanded end 12, protuberance 15, or butt 18 from pulling all the way through the securing collar 20, 21.

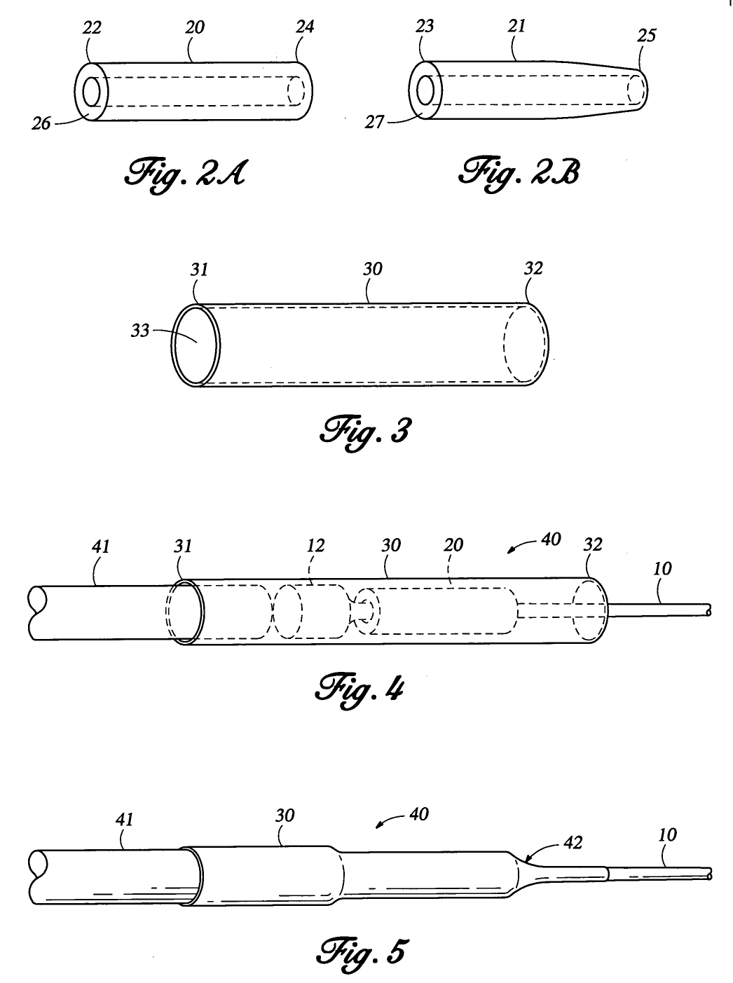

FIG. 3 shows the heat-shrinkable tubing 30 used as part of the connector of the present invention. Lengths of heat-shrinkable tubing are commercially available in many materials, sizes, and colors, e.g. TycoTUGA-series; Raychem KYNAR. The inner diameter (I.D.) of the first end 31 of the heat-shrinkable tubing 30 recovered after heating should be less than the outer diameter (O.D.) of the fly line, and the inner diameter (I.D.) of the second end 32 of the tubing 30 recovered after heating should be less than the outer diameter of the securing collar 20, 21, so that a secure connection results. A heat-activated adhesive material, such as thermosetting polyethylene ASTM D-4236, or “glue stick,” can be applied to the bore 33 of the tubing to strengthen the connection. The adhesive material can be pre-applied during the manufacture of the tubing 30, or it can be applied in the field.

FIG. 4 shows the parts of the connector 40 prior to the application of heat. The free end of the unmodified fly line 41 has been inserted into the first end 31 of the heat shrinkable tubing. The tapered end of the leader line 10 has been inserted into the first end 22 of the collar 20 and out the second end 24, with the expanded end 12 stopped by the wall 26 of the securing collar 20. The securing collar 20, holding the expanded end 12 of the leader line 10, is inserted into the second end 32 of the heat-shrinkable tubing 30 until the expanded end 12 of the leader line abuts the fly line 41. As noted supra, shallow grooves can be inscribed on the surface of the end of the fly line 41, resulting in a stronger connection.

As shown in FIG. 5, heat has been applied, shrinking the tubing 30 and forming the connector 40 between the leader line 10 and the fly line 41. The heat can be applied with a heat gun that is powered by batteries or electricity, or even with heat from a flame. The taper 42 of the connector 40 allows easy passage of the fly line 41 and leader line 10 through fly rod guides. The connector 40 is semi-rigid, allowing the presentation of leader and attached fly to extend straight from the fly line 41.

Although the connector of the present invention has been described with reference to preferred embodiments, it will be understood by those skilled in the art that additions, modifications, substitutions, deletions and other changes not specifically described are possible, and that the details herein are to be interpreted as illustrative and not as self-limiting.

I claim:

1. An assembly for connecting an enlarged butt end of a leader to an end of a fly line, the assembly comprising:
a cylindrical security collar having a bore with an inner diameter sized to allow passage of the leader, but not the butt end of the leader;
a length of heat-shrinkable tubing having a first end and a second end and further having a bore dimensioned to receive the end, of the fly line inside the first end of the tubing and further to receive into the second end of the tubing the butt end of the leader with the securing collar holding the leader, the butt end of the leader being moved proximate to the end of the fly line;
upon the application of heat, the heat-shrinkable tubing being susceptible to contracting and securely enclosing the end of the fly line, the butt end of the leader, and the securing collar.

2. The assembly of claim 1 which further comprises adhesive material applied to the bore of the heat-shrinkable tubing.

3. The assembly of claim 2 wherein the adhesive material is heat-activated.

4. The assembly of claim 1 wherein shallow grooves are inscribed on the end of the fly line.

5. An assembly for use with a fly line, the assembly comprising:
a leader having a butt end, the butt end having been enlarged by a process selected from prefabrication and mechanical alteration.

6. The assembly of claim 5 which further comprises adhesive material applied to the bore of the heat-shrinkable tubing.

7. The assembly of claim 5 wherein the adhesive material is heat-activated.

8. The assembly of claim 1 wherein shallow grooves are inscribed on the end of the fly line.

9. A method of connecting a butt end of a leader to an end of a fly line, the method comprising:
(1) enlarging the butt end of the leader by means selected from prefabrication or mechanical alteration;
(2) sliding a securing collar with a bore over an opposite end of the leader until an end of the securing collar is proximate to and stopped by the enlarged butt end of the leader;
(3) sliding the butt end of the leader and the securing collar inside a length of heat-shrinkable tubing through a first end;
(4) sliding the end of the fly line into a second end of the length of heat-shrinkable tubing until it is proximate to the enlarged butt end of the leader;
(5) applying heat to the length of heat-shrinkable tubing, causing it to contract and enclose the end of the fly line, the butt end of the leader, and the securing collar.

10. The method of claim 9 which further comprises, prior to step (2), applying adhesive to an interior surface of the heat-shrinkable tubing.

11. The method of claim 9 which further comprises, prior to step (2), inscribing shallow grooves on a surface of the end of the fly line.
